(19) United States
(12) Patent Application Publication
(10) Pub. No.: US 2002/0130728 A1
(43) Pub. Date: Sep. 19, 2002

(54) Electrical connector and transmission line

(76) Inventors: Hiroaki Kukita, Yokohama-shi (JP); Hirofumi Yamagata, Yokohama-shi (JP)

Correspondence Address: ROSENTHAL & OSHA L.L.P., 1221 MCKINNEY AVENUE, SUITE 2800, HOUSTON, TX, 77010, US

(21) Appl. No.: 10/085,952

(22) Filed: Feb. 28, 2002

(30) Foreign Application Priority Data
Mar. 19, 2001 (JP) 2001-77653

(51) Int. Cl. H01P 3/08

(52) U.S. Cl. 333/1; 333/260

(57) ABSTRACT

An electrical connector includes a first connector having first contacts; and a second connector having second contacts which are brought into contact with the first contacts when the second connector is fitted to the first connector, wherein an outer conductor, which is formed to nearly entirely surround all the first contacts and the second contacts when the first connector and the second connector are fitted to each other, is held in at lease either of the first connector and the second connector; and wherein one or more shielding conductors, which cooperate with the outer conductor to nearly entirely surround each of the first and second contacts and are held equal in potential to the outer conductor, when the first connector and the second connector are fitted to each other, are held in at least either of the first connector and the second connector.

### BACKGROUND OF THE INVENTION

The present invention relates to an electrical connector for fast signal and to a transmission line.

In recent years, out of consideration to high-speed transmission and frequency characteristic, coaxial connectors are often used as board-to-board electrical connectors for interconnecting boards built in electronic equipment such as computers. In addition, multicore connectors are often used, with increase in the number of input and output lines, such as signal lines and electric power lines, to the boards.

However, the conventional multicore connector using the coaxial terminals has the disadvantage that it is difficult to make potentials of outer conductors (GND) of the coaxial lines formed by fitting the coaxial terminals to the multicore connector equal to each other and thus it is difficult to make characteristic impedances of the coaxial lines equal to each other. In addition, the conventional electrical connector is usually formed to have a multicore structure by simply aligning the coaxial terminals in two columns and four rows, for example, and thus requires a large number of components.

It is the object of the present invention to provide an electrical connector that enables characteristic impedances of a plurality of transmission lines to be made equal to each other with ease and also requires a decreased number of components, and a transmission line.

### BRIEF SUMMARY OF THE INVENTION

An electrical connector of the present invention comprises a first connector having first contacts; and a second connector having second contacts which are brought into contact with the first contacts when the second connector is fitted to the first connector, wherein an outer conductor, which is formed to nearly entirely surround all the first contacts and the second contacts when the first connector and the second connector are fitted to each other, is held in at lease either of the first connector and the second connector; and wherein one or more shielding conductors, which cooperate with the outer conductor to nearly entirely surround each of the first and second contacts and are held equal in potential to the outer conductor, when the first connector and the second connector are fitted to each other, are held in at least either of the first connector and the second connector.

According to the electrical connector thus constructed, since the ground planes for the signal lines formed by contact of the first contacts and the second contacts are all formed by the same outer conductor and shielding conductors, the ground planes for the signal lines are made equal in potential to each other and thus the characteristic impedances of the transmission lines formed by the signal lines and the ground planes are made equal to each other with ease. As a result of this, the signals transmitted through the transmission lines can be made to have the same characteristics in phase, transmission speed, transmission loss, etc. In addition, since the electrical connector is constructed so that the signal lines can be nearly entirely surrounded by the ground planes, the signals transmitted through the transmission lines can be prevented from exerting their influences on the external or being influenced from the external, as in the case of the coaxial line.

According to the electrical connector mentioned above, when the first connector and the second connector are fitted to each other, the shielding conductors are brought into contact with each other to form a combined member. This can make the shielding conductors equal in potential to each other with ease.

The electrical connector mentioned above may include only one shielding conductor. This can provide the advantage of further reducing the number of components.

In the electrical connector mentioned above, the one or more shielding conductors lie in a region between one of the first contacts and the others of the first contacts, confronting each other, and a region between one of the second contacts and the others of the second contacts, confronting each other. According to the electrical connector thus structured, since the shielding conductors lie in the confronting region between the signal lines formed by one of the first contacts and one of the second contacts and the signal lines formed by the others of the first contacts and the others of the second contacts, the signals transmitted through the signal lines can surely be prevented from interfering with each other.

A transmission line according to the present invention comprises signal lines; an outer conductor that is formed to nearly entirely surround all the signal lines; and one or more shielding conductors which cooperate with the outer conductor to nearly entirely surround each of the signal lines and are held equal in potential to the outer conductor.

According to the transmission line thus constructed, since the ground planes for the signal lines are all formed by the same outer conductor and shielding constructors, the ground planes for the signal lines are made equal in potential to each other and thus the characteristic impedances of the transmission lines formed by the signal lines and the ground planes are made equal to each other with ease. As a result of this, the signals transmitted through the transmission lines can be made to have the same characteristics in phase, transmission speed, transmission loss, etc. In addition, since the transmission line is constructed so that the signal lines can be nearly entirely surrounded by the ground planes, the signals transmitted through the transmission lines can be prevented from exerting their influences on the external or being influenced from the external, as in the case of the coaxial line.

### BRIEF DESCRIPTION OF THE DRAWINGS

FIG. 1 is an exploded perspective view of a board-to-board electrical connector of the invention;

FIG. 2 is an illustration for illustrating the contacted state of a group of fast-signal-use terminals of the electrical connector of FIG. 1;

FIG. 3 is an illustration for illustrating the contacted state of a shield plate and contacts of the electrical connector of FIG. 1;

FIG. 4 is a perspective view of the shield plate of the electrical connector of FIG. 1; and

FIG. 5 is an illustration for illustrating transmission lines of the electrical connector of FIG. 1.

### DETAILED DESCRIPTION OF THE PREFERRED EMBODIMENTS

In the following, certain preferred embodiments of the present invention will be described with reference to the accompanying drawings.

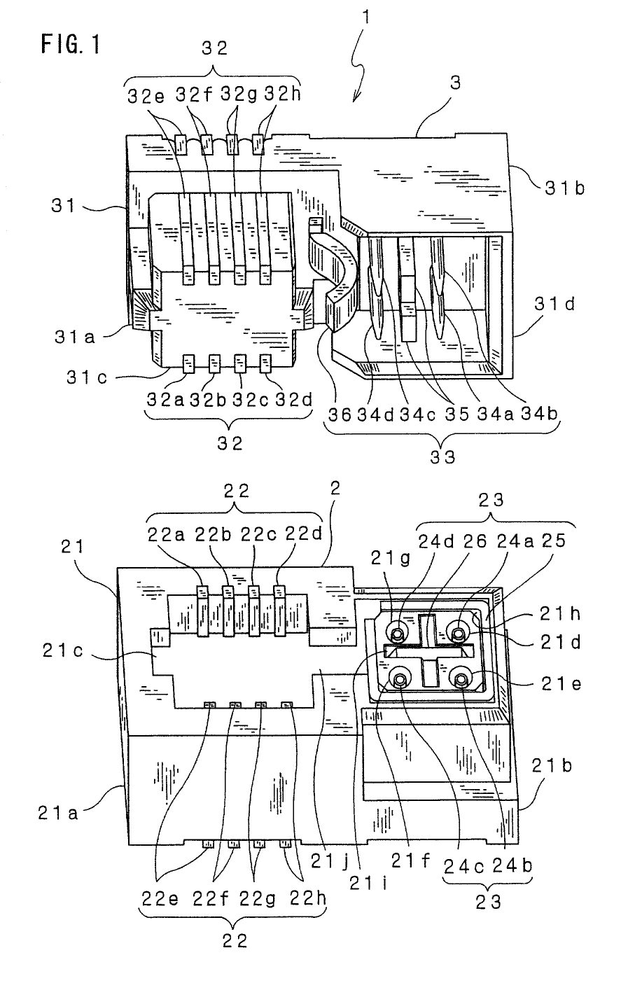

A board-to-board electrical connector 1 according to the embodiment shown in FIG. 1 comprises a pair of male and female connectors 3 and 2.

The connector 2 comprises a housing 21, a group of terminals 22 mainly used for slow signals, and a group of terminals 23 mainly used for fast signals, as shown in FIG. 1.

The housing 21 is formed in one piece which comprises a terminal-group holding portion 21a for holding the group of terminals 22 and a terminal-group holding portion 21b for holding the group of terminals 23. The terminal-group holding portion 21a has a concave portion 21c. On the other hand, the terminal-group holding portion 21b has concave portions 21d, 21e, 21f, 21g, 21h, 21i and 21j. The concave portions 21h and 21j are connected with each other. The concave portion 21h has an outer shape which shares the same center as that of a square having vertices at the concave portions 21d, 21e, 21f and 21g and substantially entirely surrounds all the concave portions 21d, 21e, 21f and 21g. The concave portion 21i having a cross shape is formed to be located in the region surrounded by the concave portion 21h and also be located between the concave portions 21d and 21e, between the concave portions 21e and 21f, between the concave portions 21f and 21g, and between the concave portions 21g and 21d, respectively.

The group of terminals 22 is held in the inner wall of the concave portion 21c provided in the terminal-group holding portion 21a of the housing 21 and comprises a total of eight contacts 22a, 22b, 22c, 22d, 22e, 22f, 22g and 22h which are identical in shape and are aligned in two columns and four rows.

The group of terminals 23 is held in the terminal-group holding portion 21b of the housing 21 and comprises a total of four contacts 24a, 24b, 24c and 24d aligned in two columns and two rows, an external shield plate 25, and a shield plate 26.

The contacts 24a, 24b, 24c and 24d are respectively cylindrical conductors which are identical in shape and size to each other. The contacts 24a, 24b, 24c and 24d are held in the terminal-group holding portion 21b of the housing 21 so as to be accommodated in the concave portions 21d, 21e, 21f and 21g, respectively. The distance between the contacts 24a and 24b, the distance between the contacts 24b and 24c, the distance between the contacts 24c and 24d, and the distance between the contacts 24d and 24a are equal to each other.

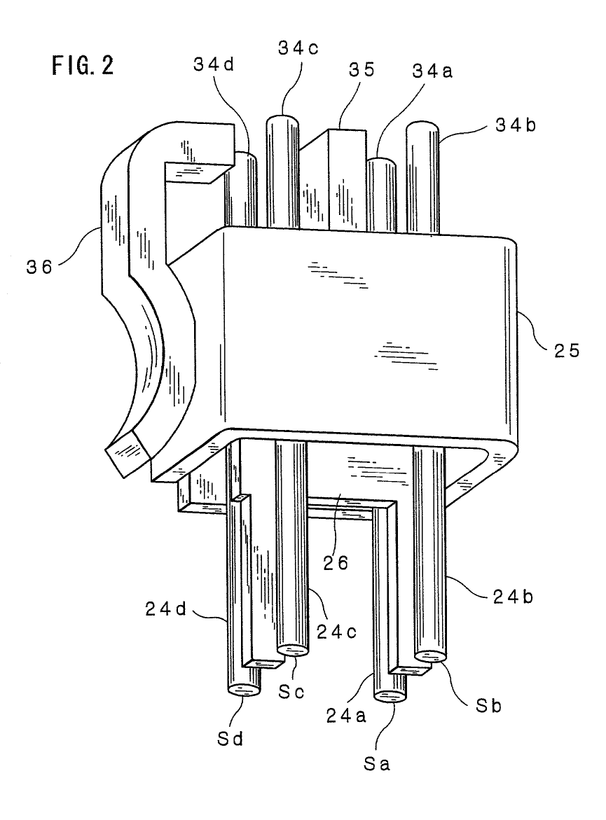

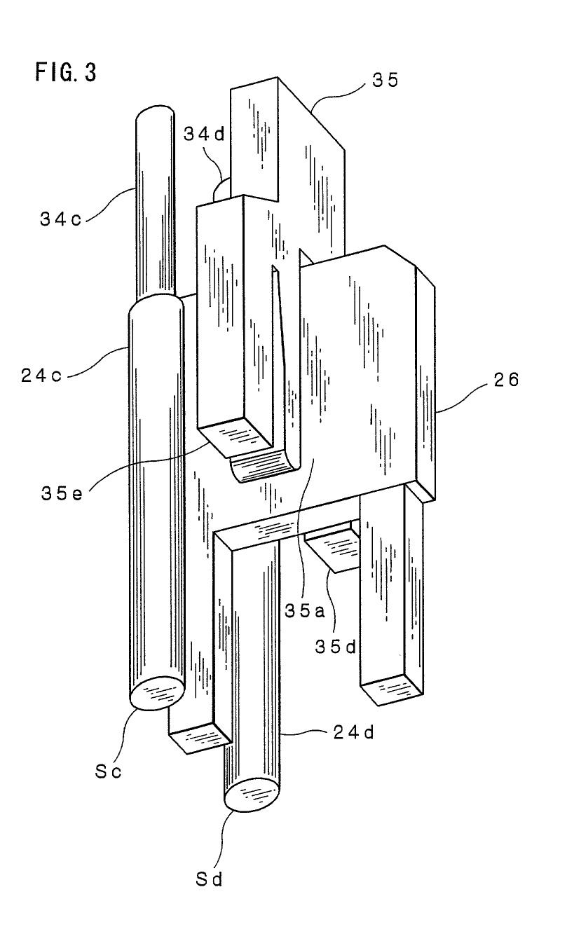

When the connector 2 and the connector 3 are fitted to each other, the contacts 24a, 24b, 24c and 24d are brought into contact with contacts 34a, 34b, 34c and 34d of the connector 3 mentioned later, respectively, to form signal lines Sa, Sb, Sc and Sd through which signals are transmitted from a printed circuit board (not shown) mounting the connector 2 thereon to a printed circuit board (not shown) mounting the connector 3 thereon or vice versa (See FIGS. 2 and 3).

The external shield plate 25 is formed to have an outer shape of substantially a square, for example, by bending a flat conductor plate. The sides of the square are twice as long as the distance between the center of the contact 24a and the center of the contact 24b. The external shield plate 25 is held in the housing 21 so as to be accommodated in the concave portion 21h provided in the terminal-group holding portion 21b, so that it surrounds all the four contacts 24a, 24b, 24c and 24d and its outer square shape shares the same center as that of a square having vertices at the four contacts 24a, 24b, 24c and 24d.

When the connector 2 and the connector 3 are fitted to each other, the external shield plate 25 is combined with a shield plate 26 mentioned later and a shield plate 35 of the connector 3 mentioned later, to form ground planes for the signal lines mentioned above.

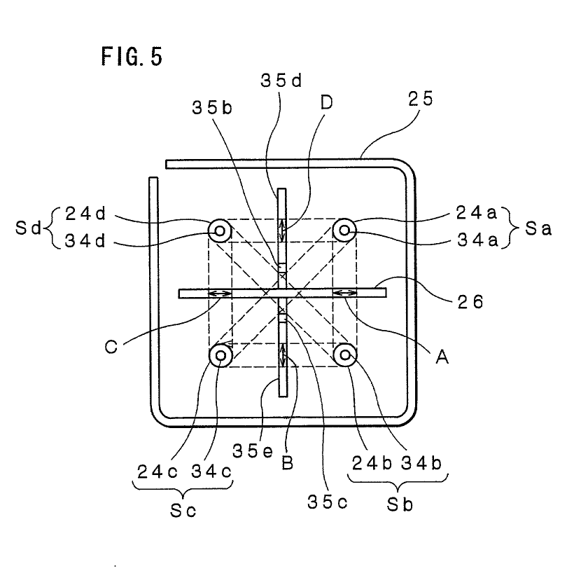

The shield plate 26 is a flat conductor plate. The shield plate 26 is accommodated in the concave portion 21i provided in the terminal-group holding portion 21b so as to be located in the external shield plate 25 and also placed in between the contacts 24a and 24b and in between the contacts 24c and 24d. It should be noted here that the shield plate 26 lies at least in a confronting region A (See FIG. 5) which the contacts 24a and 24b confront each other and in a confronting region C (See FIG. 5) which the contacts 24c and 24d confront each other.

The shield plate 26 is inserted in a notch 35a of a shield plate 35 of the connector 3 mentioned later, when the connector 2 and the connector 3 are fitted to each other, as shown in FIG. 3.

The connector 3 comprises a housing 31, a group of terminals 32 mainly used for slow signals, and a group of terminals 33 mainly used for fast signals, as shown in FIG. 1.

The housing 31 is formed in one piece which comprises a terminal-group holding portion 31a for holding the group of terminals 32 and a terminal-group holding portion 31b for holding the group of terminals 33. The terminal-group holding portion 31a a has a convex portion 31c. On the other hand, the terminal-group holding portion 31b has a “U-shaped” frame portion 31d. When the connector 2 and the connector 3 are fitted to each other, the convex portion 31c is accommodated in the concave portion 21c provided in the housing 21 of the connector 2 and the terminal-group holding portion 21b of the connector 2 is accommodated in the frame portion 31d.

The group of terminals 32 comprises a total of eight contacts 32a, 32b, 32c, 32d, 32e, 32f, 32g and 32h which are identical in shape and are aligned in two columns and four rows and is held in the side wall of the convex portion 31c provided in the terminal-group holding portion 31a of the housing 31. When the connector 2 and the connector 3 are fitted to each other, the contacts 32a, 32b, 32c, 32d, 32e, 32f, 32g and 32h come into contact with the contacts 22a, 22b, 22c, 22d, 22e, 22f, 22g and 22h, respectively.

The group of terminals 33 is held in the terminal-group holding portion 31b of the housing 31 and comprises a total of four contacts 34a, 34b, 34c and 34d aligned in two columns and two rows, an external shield plate 35, and a connecting member 36.

The contacts 34a, 34b, 34c and 34d are substantially cylindrical conductors which are identical in shape and size to each other. The contacts 34a, 34b, 34c and 34d are respectively held in the terminal-group holding portion 31b of the housing 31. The distance between the contacts 34a and 34b, the distance between the contacts 34b and 34c, the distance between the contacts 34c and 34d, and the distance between the contacts 34d and 34a are equal to each other.

When the connector 2 and the connector 3 are fitted to each other, the contacts 34a, 34b, 34c and 34d respectively come into contact with the contacts 24a, 24b, 24c and 24d of the connector 2, to form the signal lines Sa, Sb, Sc and Sd (See FIGS. 2 and 3).

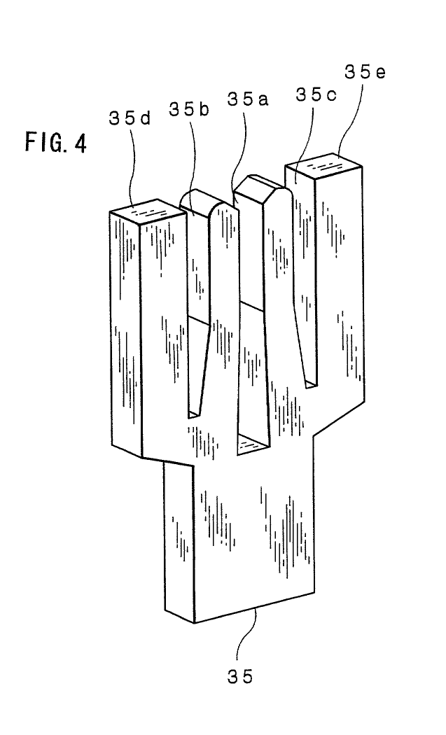

When the connector 2 and the connector 3 are fitted to each other, the shield plate 35 comes into contact with the shield plate 26 of the connector 2 to form a combined member, as shown in FIG. 3. The shield plate 35 has a form having notches 35a, 35b and 35c formed, for example, by partly cutting off the flat conductor plate, as shown in FIG. 4, and has a size to be fitted in the external shield plate 25 of the connector 2 when the connector 2 and the connector 3 are fitted to each other, as shown in FIG. 2. The shield plate 35 is held in the terminal-group holding portion 31b of the housing 31 so that its shielding portion 35d can be placed in between the contacts 34a and 34d and also its shielding portion 35e can be placed in between the contacts 35b and 35c. The shielding portion 35d of the shield plate 35 lies at least in a confronting region D (See FIG. 5) which the contacts 34a and 34d confront each other and the shielding portion 35e lies at least in a confronting region C (See FIG. 5) which the contacts 34b and 34c confront each other.

The notch 35a of the shield plate 35 is the opening for the shield plate 26 of the connector 2 to be inserted in when the connector 2 and the connector 3 are fitted to each other, as shown in FIG. 3. The notch 35a has width smaller than thickness of the shield plate 26, such that when the connector 2 and the connector 3 are fitted to each other, the shield plate 35 and the shield plate 26 are surely brought into contact with each other. The notches 35b and 35c of the shield plate 35 are provided to allow the shield plate 26 to be easily inserted into the notch 35a of the shield plate 35. When the connector 2 and the connector 3 are fitted to each other, the notches 35b and 35c are provided in the shield plate 35 at such locations and of such size that the ground planes (the shield plate 26 and the shield plate 35) will lie in the confronting region which the signal lines Sa and Sc confront each other and in the confronting region which the signal lines Sb and Sd confront each other (See FIG. 5).

When the connector 2 and the connector 3 are fitted to each other, the shield plate 35 is combined with the external shield plate 25 and shield plate 26 of the connecter 2, to form the ground planes for the signal lines Sa, Sb, Sc and Sd.

The connecting member 36 is a substantially S-shaped conductor. When the connector 2 and the connector 3 are fitted to each other, the connecting member 36 is inserted in the concave portion 21j provided in the housing 21 of the connector 2 and is brought into contact with the external shield plate 25 of the connector 2, as shown in FIG. 2.

In the following, reference will be given to the transmission lines formed by the group of terminals 23 of the connector 2 and the group of terminals 33 of the connector 3 when the connector 2 and the connector 3 are fitted to each other.

When the connector 2 and the connector 3 are fitted to each other, the contacts 24a, 24b, 24c and 24d of the connector 2 and the contacts 34a, 34b, 34c and 34d of the connector 3 respectively come into contact with each other, to form four signal lines Sa, Sb, Sc and Sd, as shown in FIG. 5. Also, the ground planes are formed by the external shield plate 25 and the shield plate 26 of the connector 2 and the shield plate 35 of the connector 3.

It should be noted here that the external shield plate 25 forming the ground planes nearly entirely surrounds all the signal lines Sa, Sb, Sc and Sd, as shown in FIGS. 2 and 5. Also, the ground planes (the shield plate 26 and the shield plate 35) lie in the confronting region A which the signal lines Sa and Sb confront each other, the confronting region B which the signal lines Sb and Sc confront each other, the confronting region C which the signal lines Sc and Sd confront each other, and the confronting region D which the signal lines Sd and Sa confront each other, as shown in FIG. 5. In addition, the ground planes (the shield plate 26 and the shield plate 35) lie in the region which the signal lines Sa and Sc confront each other and the region which the signal lines Sb and Sd confront each other, as shown in FIG. 5. Thus, the signal lines Sa, Sb, Sc and Sd are each nearly entirely surrounded by the ground planes (the external shield plate 25, the shield plate 26 and the shield plate 35).

It should be noted that although the external shield plate 25 does not surround the signal lines Sa, Sb, Sc and Sd entirely, the external shield plate 25 is just allowed to surround the signals lines Sa, Sb, Sc and Sd in such a manner that the signal are neither influenced from external nor exert an influence on the external. Although gap lie between the external shield plate 25 and the shield plates 26 and 35, the shield plates 26 and 35 are allowed to be located in proximity to the external shield plate 25 so as to present the signal lines from exerting their influences on each other. Further, although the notches 35a, 35b and 35c are formed in the shield plate 35, it is allowed to be locations and size so as to prevent the signal lines from exerting their influences on each other.

The signal lines Sa, Sb, Sc and Sd are respectively at the centers of the regions surrounded by the ground planes placed therearound, as shown in FIG. 5.

Four transmission lines having the above-mentioned physical relationship between the signal lines Sa, Sb, Sc and Sd and the ground planes are formed by the signal lines Sa, Sb, Sc and Sd and the ground planes and are identical in shape and size to each other.

The shield plate 26 of the connector 2 and the shield plate 35 of the connector 3 making contact with each other are connected with the ground plane of the printed circuit board (not shown) and also the external shield plate 25 of the connector 2 is connected with the ground plane of the printed circuit board (not shown) via the connecting member 36. This can allow the external shield plate 25 and the shield plate 26 of the connector 2 and the shield plate 35 of the connector 3 to be held equal in potential to each other. Also, since the ground planes for the signal lines Sa, Sb, Sc and Sd are the same, the ground planes of the transmission lines are made equal in potential to each other.

As mentioned above, according to the electrical connector according to the embodiment, since the transmission lines are made identical in shape and size and also the ground planes of the transmission lines are made equal in potential to each other, the characteristic impedances of the transmission lines are made equal to each other. This can allow the signals transmitted through the transmission lines to have the same characteristics in phase, transmission speed, transmission loss, etc.

In addition, the signal lines Sa, Sb, Sc and Sd are nearly entirely surrounded by the ground planes and also the ground planes (the shield plate 26 and the shield plate 35) lie in the confronting region A between the signal lines Sa and Sb, the confronting region B between the signal lines Sb and Sc, the confronting region C between the signal lines Sc and Sd, the confronting region D between the signal lines Sd and Sa, the confronting region between the signal lines Sa and Sc, and the confronting region between the signal lines Sb and Sd. Therefore, as in the case of the coaxial line, the signals transmitted through the signal lines Sa, Sb, Sc and Sd can be prevented from being influenced from the external or exerting their influences on the external. In addition, the signals transmitted therethrough can be prevented from interfering with each other. Further, for example when the signal lines and the ground planes are arranged in the physical relation mentioned above, the substantially same transmission characteristics as those of the coaxial line can be achieved.

Further, since the common members (the external shield plate 25, the shield plate 26 and the shield plate 35) are used for the ground planes for the signal lines Sa, Sb, Sc and Sd, the number of components can be reduced, as compared with the case where the coaxial terminals are simply aligned in order. For example when four coaxial terminals are aligned in two columns and two rows, four contacts for the signal lines and four outer conductors for the ground planes are required for each of a pair of male and female connectors, so that a total of sixteen components are required. In contrast to this, according to the electrical connector of the embodiment of the invention, a total of eleven components are required, and thus the number of components can be decreased. It should be noted that according to the electrical connector of the invention, the more the number of signal lines for fast-signal increase, the more the number of components decrease, as compared with the electrical connector in which the coaxial connectors are simply aligned in order.

While the preferred embodiment of the present invention has been illustrated above, it will be understood that the present invention should not be limited to the embodiment illustrated above and various changes and modifications in design may be made in the invention within the scope of the claims. For example, while in the embodiment illustrated above, the four fast-signal signal lines Sa, Sb, Sc and Sd are used, any adequate number of signal lines (e.g., a total of six signal lines aligned in two columns and three rows or a total of nine signal lines aligned in three columns and three rows) may selectively be used. Also, if the shield plates used have the capability of preventing the signals from interfering with each other, then each of those shield plates may be arranged between each pair of confronting signal lines.

While in the embodiment illustrated above, the shield plates are provided one for each of the connectors 2 and 3, modification may be made such that a combined shield plate having a cross shape may be provided for either of the connectors 2 and 3. In this modification, the number of components can be reduced further.

Further, as long as a desired characteristic impedance can be obtained, the shape of the external shield plate and shield plate and the physical relation between the signal lines Sa, Sb, Sc and Sd and the ground planes (the external shield plate 25, the shield plate 26, and the shield plate 35) are not limited to those mentioned above. The four transmission lines formed by the signal lines Sa, Sb, Sc and Sd and the ground planes may be modified in design to be made different in size and shape from each other.

Further, it is needless to say that the present invention is applicable to various types of electrical connectors as well as to the board-to-board electrical connector. Also, it is needless to say that the transmission line having the shape mentioned above can be used as the transmission line in the cable as well as the transmission lines formed at the fitting of the electrical connector.

What is claimed is:

1. An electrical connector comprising:
a first connector having first contacts; and
a second connector having second contacts which are brought into contact with the first contacts when the second connector is fitted to the first connector,
wherein an outer conductor, which is formed to nearly entirely surround all the first contacts and the second contacts when the first connector and the second connector are fitted to each other, is held in at lease either of the first connector and the second connector; and
wherein one or more shielding conductors, which cooperate with the outer conductor to nearly entirely surround each of the first and second contacts and are held equal in potential to the outer conductor, when the first connector and the second connector are fitted to each other, are held in at least either of the first connector and the second connector.

2. The electrical connector according to claim 1, wherein when the first connector and the second connector are fitted to each other, the shielding conductors are brought into contact with each other to form a combined member.

3. The electrical connector according to claim 1, which includes only one shielding conductor.

4. The electrical connector according to any one of claim 1, wherein the one or more shielding conductors lie in a region between one of the first contacts and the others of the first contacts, confronting each other, and a region between one of the second contacts and the others of the second contacts, confronting each other.

5. The electrical connector according to any one of claim 2, wherein the one or more shielding conductors lie in a region between one of the first contacts and the others of the first contacts, confronting each other, and a region between one of the second contacts and the others of the second contacts, confronting each other.

6. The electrical connector according to any one of claim 3, wherein the one or more shielding conductors lie in a region between one of the first contacts and the others of the first contacts, confronting each other, and a region between one of the second contacts and the others of the second contacts, confronting each other.

7. A transmission line comprising:
signal lines;
an outer conductor that is formed to nearly entirely surround all the signal lines; and
one or more shielding conductors, which cooperate with the outer conductor to nearly entirely surround each of the signal lines and are held equal in potential to the outer conductor.
